(19) United States
(12) Patent Application Publication
(10) Pub. No.: US 2012/0167088 A1
(43) Pub. Date: Jun. 28, 2012

(54) SYSTEM FOR MOVING INDIVIDUAL VIRTUAL MACHINE AMONG CLOUD COMPUTING ENVIRONMENT AND METHOD THEREOF

(75) Inventor: Song Woo SOK, Daejeon (KR)

(73) Assignee: Electronics and Telecommunications Research Institute, Daejeon (KR)

(21) Appl. No.: 13/335,435

(22) Filed: Dec. 22, 2011

(30) Foreign Application Priority Data
Dec. 23, 2010 (KR) 10-2010-0134078

(51) Int. Cl. G06F 9/455

(52) U.S. Cl. 718/1

(57) ABSTRACT

Disclosed is a method for moving a personal virtual machine among clouds in a cloud computing environment, including: requesting metadata for driving a virtual machine allocated to a user and an updated file in a first cloud; generating a virtual machine image in a second cloud based on the metadata and the updated file; and reproducing the virtual machine by using the generated virtual machine image.

### CROSS-REFERENCE TO RELATED APPLICATIONS

This application claims priority to and the benefit of Korean Patent Application No. 10-2010-0134078 filed in the Korean Intellectual Property Office on Dec. 23, 2010, the entire contents of which are incorporated herein by reference.

### TECHNICAL FIELD

The present invention relates to a system for moving a personal virtual machine among clouds in a cloud computing environment and a method thereof that can move users' individual virtual machines among clouds using different virtualization technologies under a cloud computing environment which is a technology integrating and providing computing resources by using a virtualization technology.

### BACKGROUND

In recent years, cloud computing which has been a hot issue is called a computing environment capable of using IT related services such as storing data, a network, and the use of contents at once through a server on the Internet. The cloud computing brings about a paradigm shift of new computing.

Various system virtualization technologies used to provide a cloud service at present are, for example, Xen, KVM, Hyper-V, VMware, and the like. IAAS cloud service providers provide the cloud service by adopting one or some of the various virtualization technologies.

When the system virtualization technologies are different from each other, structures and generation methods of virtual machine disk images used in the respective virtualization technologies are also different from each other. As a result, it becomes almost impossible to transfer an image of a virtual machine generated and used by a user among cloud service companies using different virtualization technologies.

Accordingly, when the user generates and uses the virtual machine by selecting one cloud service provider, the user is subordinated to the corresponding cloud service provider to lose an ability to select the cloud service provider.

In order to select another cloud service provider, the user should passively back up all data of an existing virtual machine which is being used and recover the back-up data again by generating the virtual machine from a new cloud service provider.

Such a process requires much time and due to a difference from an originally executed environment, the virtual machine may not be in the same state as the virtual machine which the user originally used.

In user virtual machine image data, data which the user generates while using the virtual machine and system software (an OS, a development tool, various services, and the like) which the cloud service provider provides originally coexist. Since data which the user does not generate among them is owned by the corresponding cloud provider, there is a legal problem in moving a user virtual machine image entirely to the outside of a cloud of the cloud service provider. Therefore, by separating the data generated by the user and the data provided by the cloud provider, a method capable of transferring only the data generated by the user is required.

Since there are many cases where another cloud provider can also easily provide other data (system software) other than user data, it is more advantageous temporally and economically to move the data except for the data.

### SUMMARY

The present invention has been made in an effort to generate a virtual machine having the same level of state as an original virtual machine by extracting only data generated by a user from a virtual machine image and moving the data among cloud service providers using different virtualization technologies, thereby easing user's inconvenience.

Further, the present invention has been made in an effort to allow a user to be less vulnerable to dependency on a cloud service provider by allowing a user's virtual machine to freely move among different cloud service providers to cause a competition in good faith among the cloud service providers, thereby providing the development of a cloud service technology so as for the user to have a more improved cloud service using environment.

An exemplary embodiment of the present invention provides a method for moving a personal virtual machine among clouds, including: requesting metadata for driving a virtual machine allocated to a user and an updated file in a first cloud; generating a virtual machine image in a second cloud based on the metadata and the updated file; and reproducing the virtual machine by using the generated virtual machine image.

The method may further include separating, by the user, files modified while using the virtual machine from an original image and storing the modified files.

The method may further include requesting, by the user, the virtual machine in the first cloud to be allocated with the virtual machine.

The method may further include requesting, by the user, the virtual machine to be allocated with the virtual machine in the first cloud, when there is no virtual machine in the first cloud.

The method may further include: requesting, by the user, generation of the virtual machine to a second cloud in order to move the virtual machine of the first cloud to a second cloud.

Another exemplary embodiment of the present invention provides a system for moving a personal virtual machine among clouds, including: a virtual machine image generating unit generating a virtual machine image for a user in a second cloud based on metadata for driving a virtual machine allocated to the user and a file updated by the user in a first cloud; and a virtual machine reproducing unit reproducing the virtual machine of the user by using the generated virtual machine image.

The system may further include: a CoW file system separating the updated file from original data of the virtual machine; and a virtual machine storing system storing the updated file and the original data.

The metadata may include at least one of an OS name, a version and hardware information of the virtual machine, a list of all files, the size of each file, and an md5sum value of each file.

The first cloud and the second cloud may have different cloud service providers.

The first cloud and the second cloud may have different virtualization solutions.

The present invention has the following effects.

According to exemplary embodiments of the present invention, since a virtual machine can be reproduced by moving the virtual machine configured and used by a user even among cloud platforms configured by using different virtualization technologies, dependency on the cloud platform can be remarkably reduced.

Further, according to the exemplary embodiments of the present invention, it is possible to allow a user's virtual machine image to move among different cloud platforms as necessary, thereby improving user's convenience.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram for describing a system for moving a personal virtual machine among clouds in a cloud computing environment according to an exemplary embodiment of the present invention.

FIG. 2 is a block diagram for describing a system for moving a personal virtual machine among clouds in a cloud computing environment according to an exemplary embodiment of the present invention.

FIG. 3 is a block diagram for describing the structure of a virtual machine to which a CoW file system is applied according to an exemplary embodiment of the present invention.

FIG. 4 is a flowchart for describing a method for moving a personal virtual machine among clouds in a cloud computing environment according to an exemplary embodiment of the present invention.

FIG. 5 is a flowchart for describing file reading in a CoW file system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension. In addition, parts not related with principal features of the present invention will be omitted in the accompanying drawings in order to clearly describe the present invention.

Throughout the specification, unless explicitly described to the contrary, the word “comprise” and variations such as “comprises” or “comprising”, will be understood to imply the inclusion of stated elements but not the exclusion of any other elements.

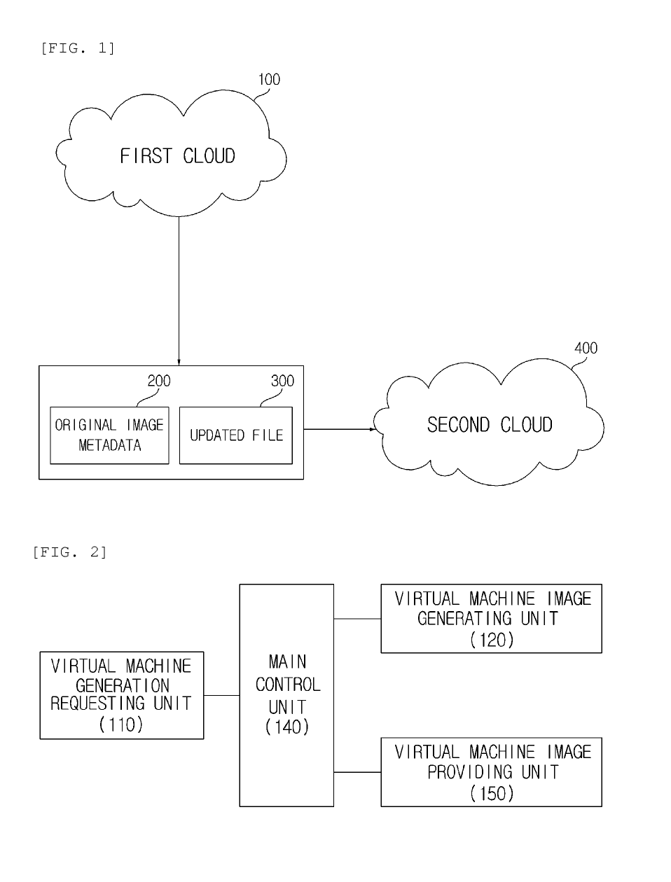

FIG. 1 is a diagram for describing a system for moving a personal virtual machine among clouds in a cloud computing environment according to an exemplary embodiment of the present invention.

Referring to FIG. 1, the system for moving a personal virtual machine among clouds according to the exemplary embodiment of the present invention provides original image metadata 200 and an updated file 300 to clouds using different virtualization technologies.

The cloud computing is based on a computing environment capable of using IT related services such as storing data, a network, and the use of contents at once through a server on the Internet, and integrates and provides computing resources that exist at different physical locations by using a virtualization technology.

The cloud computing according to the exemplary embodiment of the present invention may be provided as systems capable of communicating with each other through a wired/wireless network and may be provided to virtualize and use computing power on the Internet like a local computing power based on the virtualization technology.

The cloud computing is set so that a virtual desktop service is implemented as a realistic service type and a cloud service which is a virtual logical computer is configured by binding a plurality of physical servers and thereafter, the physical servers may be used while being mounted on the virtual machine.

The original image metadata 200 includes information on an original image of the virtual machine.

That is, the original image metadata 200 is provided to generate the same virtual machine and disk image as the original image of the virtual machine in the clouds using the different virtualization technologies.

The original image metadata 200 includes basic information and additional information on the original image of the virtual machine.

TABLE 1

| | |
|---|---|
| Basic | OS name, version, virtual machine hardware |
| information | information (CPU, memory, and NIC) |
| Additional | List of all files (including a file path), each |
| information | file size, md5sum value of each file |

FIG. 2 is a block diagram of a system for moving a personal virtual machine among clouds according to an exemplary embodiment of the present invention.

As shown in FIG. 2, the system for moving a personal virtual machine among clouds includes a virtual machine generation requesting unit 110, a virtual machine image generating unit 120, a virtual machine image providing unit 130, and a main control unit 140.

The virtual machine generation requesting unit 110 requests generation of a virtual machine for the user so as to move a virtual machine of a first cloud to a second cloud and transmits the metadata 200 to the second cloud.

The virtual machine image generating unit 120 generates the virtual machine image for the user in the second cloud based on the metadata for driving the virtual machine allocated to the user and the file updated by the user in the first cloud.

The virtual machine image providing unit 130 reproduces and provides the virtual machine of the user to the user by using the generated virtual machine image.

The main control unit 140 controls the virtual machine generation requesting unit 110, the virtual machine image generating unit 120, and the virtual machine image providing unit 130 so as to reproduce the virtual machine of the first cloud in the second cloud.

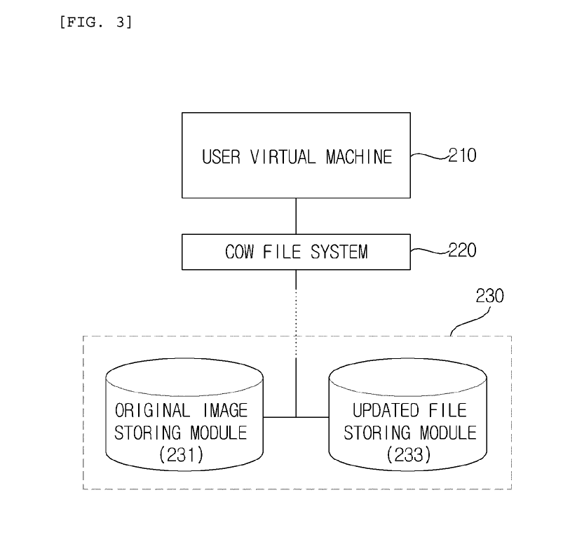

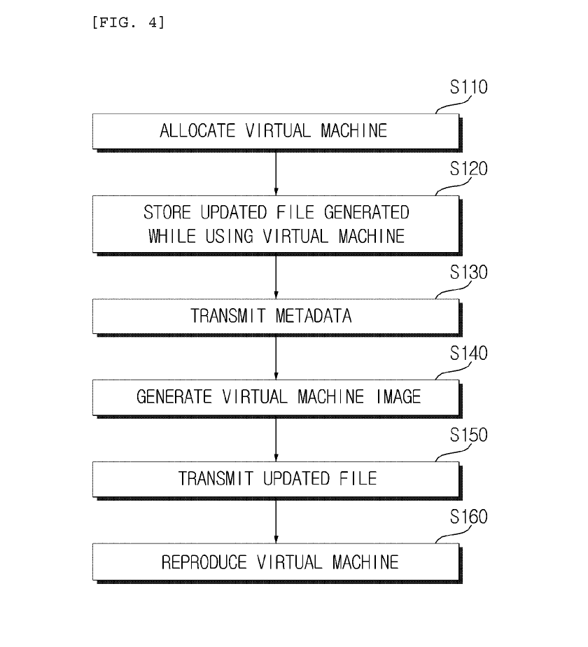

FIG. 3 is a block diagram for describing the structure of a virtual machine to which a CoW file system is applied according to an exemplary embodiment of the present invention.

As shown in FIG. 3, the system for moving a personal virtual machine among clouds according to the exemplary embodiment of the present invention adopts a file-based copy-on-write technique.

The virtual machine adopting the CoW technique includes a user virtual machine 210 generating the virtual machine, a CoW file system 220 separating the original image of the virtual machine and the updated file, and a virtual machine storing system 230 storing the original image of the virtual machine and the updated file.

The CoW file system 220 judges whether or not the updated file exists and shows the original image of the virtual machine when there is no data associated with the user.

The virtual machine storing system 230 includes an original image storing module 231 storing the original image of the virtual machine and an updated file storing module 233 storing the updated file.

Hereinafter, a method for moving a personal virtual machine among clouds in a cloud computing environment according to an exemplary embodiment of the present invention will be described.

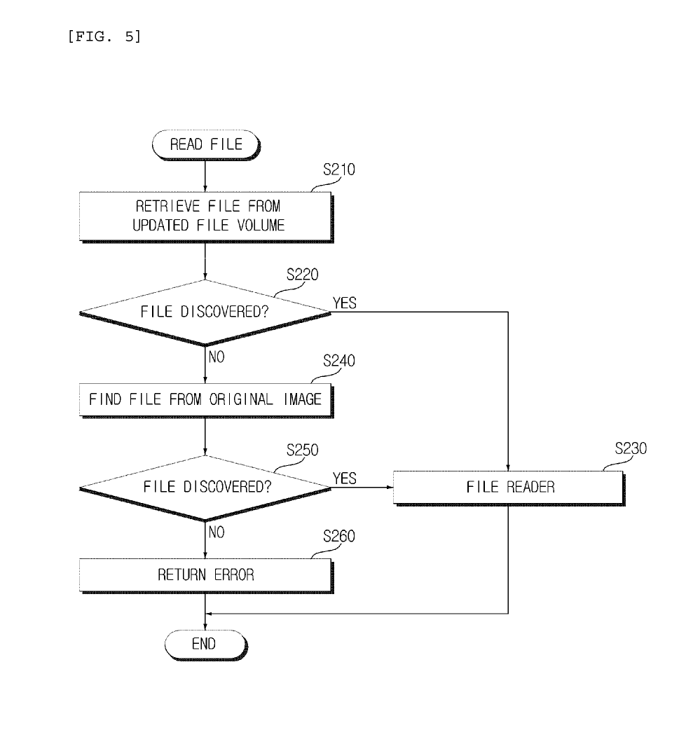

FIG. 4 is a flowchart for describing a method for moving a personal virtual machine among clouds in a cloud computing environment according to an exemplary embodiment of the present invention.

Referring to FIG. 4, one exemplary embodiment of a second cloud using a different virtualization technology from a first cloud will be described.

First, the first cloud receives a request for generating a virtual machine from a user and allocates the virtual machine to the user (S110).

The first cloud may be provided so that a virtual desktop service is implemented as a realistic service type and a cloud system which is a virtual logical computer is configured by binding a plurality of physical servers and thereafter, the physical servers may be used while being mounted on the virtual machine.

The first cloud stores an updated file generated while using the virtual machine in an additional storage space (S120).

The updated file includes user changed data due to the use of the virtual machine in the first cloud and is stored in an updated file storing module 233.

The first cloud requests a second cloud to generate the virtual machine through a virtual machine generation requesting unit 110 in order to move the virtual machine to the second cloud and transmits metadata to the second cloud (S130).

That is, in step S130, the first cloud and the second cloud may be provided to have different service providers and virtualization solutions.

The second cloud generates a virtual machine image by using the metadata transmitted from the first cloud (S140).

In step S140, the virtual machine image of the first cloud is generated by using the metadata through a virtual machine image generating unit 120.

Next, the first cloud transmits the updated file to the second cloud (S150).

The second cloud reproduces the virtual machine of the first cloud by using the updated file and the metadata received from the first cloud (S160).

In the method for moving a personal virtual machine among clouds in a cloud computing environment according to the exemplary embodiment of the present invention, a method of reading a file in a CoW file system will be described.

FIG. 5 is a flowchart for describing file reading in a CoW file system according to an exemplary embodiment of the present invention.

The CoW file system of the exemplary embodiment of the present invention retrieves the updated file stored in the updated file storing module 231 (S210).

Next, the CoW file system judges whether or not the updated file exists (S220) and reads the updated file when the updated file exists (S230).

As a result of the judgment in step S220, the CoW file system retrieves an original image of the virtual machine when the updated file does not exist (S240).

Meanwhile, the CoW file system judges whether or not the corresponding file exists in the original image of the virtual machine (S250) and proceeds to step S230 when the original image exists.

When the file is not discovered in step S230, the CoW file system judges a state as an error (S260) and may include terminating file reading in the CoW file system.

According to exemplary embodiments of the present invention, since a virtual machine can be reproduced by moving the virtual machine configured and used by a user even among cloud platforms configured by using different virtualization technologies, dependency on the cloud platform can be remarkably reduced.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for moving a personal virtual machine among clouds in a cloud computing environment, comprising:
requesting metadata for driving a virtual machine allocated to a user and an updated file in a first cloud;
generating a virtual machine image in a second cloud based on the metadata and the updated file; and
reproducing the virtual machine by using the generated virtual machine image.

2. The method of claim 1, further comprising separating, by the user, files modified while using the virtual machine from an original image and storing the modified files.

3. The method of claim 1, further comprising requesting, by the user, the virtual machine in the first cloud to be allocated with the virtual machine.

4. The method of claim 1, further comprising requesting, by the user, the virtual machine to be allocated with the virtual machine in the first cloud when there is no virtual machine in the first cloud.

5. The method of claim 1, further comprising requesting, by the user, generation of the virtual machine to a second cloud in order to move the virtual machine of the first cloud to the second cloud.

6. A system for moving a personal virtual machine among clouds in a cloud computing environment, comprising:
a virtual machine image generating unit generating a virtual machine image in a second cloud based on metadata for driving a virtual machine allocated to a user and a file updated by the user in a first cloud; and
a virtual machine reproducing unit reproducing the virtual machine of the user by using the generated virtual machine image.

7. The system of claim 6, further comprising:
a CoW file system separating the updated file from original data of the virtual machine; and
a virtual machine storing system storing the updated file and the original data.

8. The system of claim 6, wherein the metadata includes at least one of an OS name, a version and hardware information of the virtual machine, a list of all files, the size of each file, and an md5sum value of each file.

9. The system of claim 6, wherein the first cloud and the second cloud have different cloud service providers.

10. The system of claim 6, wherein the first cloud and the second cloud have different virtualization solutions.
